(19) United States
(12) Patent Application Publication
(10) Pub. No.: US 2024/0376730 A1
(43) Pub. Date: Nov. 14, 2024

(54) SWIVEL ANCHOR

(71) Applicant: Iron Fusion Enterprise, LLC, Cedar City, UT (US)

(72) Inventors: Edson Harker, Cedar City, UT (US); Parley Harker, Cedar City, UT (US); Glayden Holm, Cedar City, UT (US)

(73) Assignee: Iron Fusion Enterprise, LLC, Cedar City, UT (US)

(21) Appl. No.: 18/658,490

(22) Filed: May 8, 2024

Related U.S. Application Data
(60) Provisional application No. 63/500,676, filed on May 8, 2023.

(51) Int. Cl. E04G 21/32; A62B 35/00

(52) U.S. Cl. CPC E04G 21/328; A62B 35/0068; E04G 21/3214

(57) ABSTRACT

A swivel anchor includes a handle, a central rod, a nut, a swivel ring having an anchor ring and a base member, and an adjustable anchor bar configured to toggle between a vertical configuration and horizontal configuration. The swivel ring is configured to freely rotate 360 degrees around the central rod. A harness or self-retracting lifeline may be couplable to the anchor ring, providing an anchor point used by workers for fall protection. The anchor bar features a tubular body having an indented top surface with machined grooves that provide additional means of friction against a deck.

### CROSS-REFERENCE TO RELATED APPLICATIONS

This application claims the benefit of U.S. Provisional Application Ser. No. 63/500,676, filed on May 8, 2023, which is incorporated herein by reference.

### TECHNICAL FIELD

The present disclosure relates generally to rooftop anchors. In particular, the present disclosure relates to a portable swivel anchor that provides a 360-degree field of work.

### BACKGROUND

Rooftop anchors are a vital part of a building's fall protection system that maintain worker safety when operating from heights. Locations for anchor points are carefully selected to provide broad access to the worksite while also minimizing damage to the roof during installation. Nevertheless, many rooftop anchors penetrate the roofing membrane, requiring repairs to be made at the conclusion of the project. Alternative, non-penetrating rooftop anchors require heavy bases that are difficult to move around the jobsite. Some examples of rooftop anchor systems include weldable rooftop anchors, cast-in-place anchorages, beam-wrap anchorages, and bolt-through anchorages. Each of these systems establishes an anchor point to which safety devices such as a lanyards, self-retracting lifelines, or ropes are coupled to ensure that the free fall distance, total fall distance, and swing falls are kept below limitations set forth by the Occupational Safety and Health Administration.

Many penetrating rooftop anchors cause extensive damage to the roof, potentially harming its structural integrity and reducing its resistance to various weather conditions. On the other hand, the weight and extensive setup time required by non-penetrating rooftop anchors make usage burdensome around the jobsite. Workers must take down, reposition, and reinstall heavy, non-penetrating rooftop anchors whenever transitioning to different areas of the jobsite. Moreover, the field of work for both types of rooftop anchor systems is limited.

Accordingly, there is a need for an anchor that is quickly secured, does not harm the structural integrity of the building, and that allows full rotation while in use. The swivel anchor disclosed herein solves these and other problems.

### SUMMARY OF EXAMPLE EMBODIMENTS

In some embodiments, a swivel anchor comprises a handle, a central rod, a nut, a swivel ring having an anchor ring and a base member, and an adjustable anchor bar configured to toggle between a vertical configuration and horizontal configuration. The swivel ring is configured to freely rotate 360-degrees around the central rod, providing an expanded field of work for a user.

The anchor bar comprises a tubular body having an indented top surface that comprises machined grooves that provide additional means of friction against the deck. The tubular body also comprises a channel configured to align with, and envelop, the central rod when the swivel anchor is in the vertical configuration, compactly collapsing for portability and ease of installation and removal during use.

A method of using a swivel anchor, in some embodiments, comprises drilling a hole through a top surface of a deck, inserting the swivel anchor, in the vertical configuration, through the hole, maneuvering the anchor bar to a horizontal configuration, and tightening the nut along the central rod of the swivel anchor until flush against the swivel ring. A user may then couple a harness or self-retracting lifeline to the anchor ring, wherein the anchor ring is rotatable 360-degrees about the central rod, providing an increased field of work. To remove the swivel anchor, a user loosens the nut and pushes the handle downwards towards the deck, thereby maneuvering the anchor bar again to the vertical position where it may then be retracted through the drilled hole.

### BRIEF DESCRIPTION OF THE DRAWINGS

FIG. 1 illustrates a top, front side perspective view of a swivel anchor in a vertical configuration;

FIG. 2 illustrates a left, side elevation view of a swivel anchor in a vertical configuration;

FIG. 3 illustrates a front elevation view of a swivel anchor in a vertical configuration;

FIG. 4 illustrates a right, side elevation view of a swivel anchor in a vertical configuration;

FIG. 5 illustrates a rear elevation view of a swivel anchor in a vertical configuration;

FIG. 6 illustrates a bottom plan view of a swivel anchor in a vertical configuration;

FIG. 7 illustrates a top, front side perspective view of a swivel anchor in a horizontal configuration;

FIG. 8 illustrates an exploded, top, front, side perspective view of a swivel anchor;

FIG. 9 illustrates a front elevation view of a swivel anchor in a horizontal configuration;

FIG. 10 illustrates a top plan view of a swivel anchor in a horizontal configuration;

FIG. 11 illustrates a right, side elevation view of a swivel anchor in a horizontal configuration;

FIG. 12 illustrates a front elevation view of a swivel anchor in use;

FIG. 13 illustrates a front perspective view of a swivel anchor being installed through an anchor surface;

FIG. 14 illustrates a front perspective view of a swivel anchor as the anchor bar is being maneuvered into a horizontal position on an underside of the anchor surface;

FIG. 15 illustrates a front perspective view of a swivel anchor in preparation for being secured to the anchor surface; and

FIG. 16 illustrates a front perspective view of a swivel anchor secured to an anchor surface.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for an anchor that is quickly secured, does not harm the structural integrity of the building, and that allows full rotation while in use. Other systems in the prior art either require undue setup time, have a limited work field, or cause harm to the structural integrity to the building/roof. The swivel anchor disclosed herein solves these and other problems.

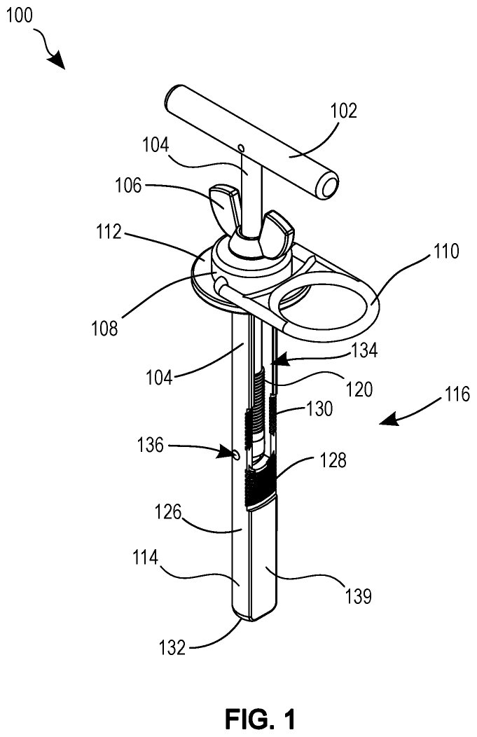

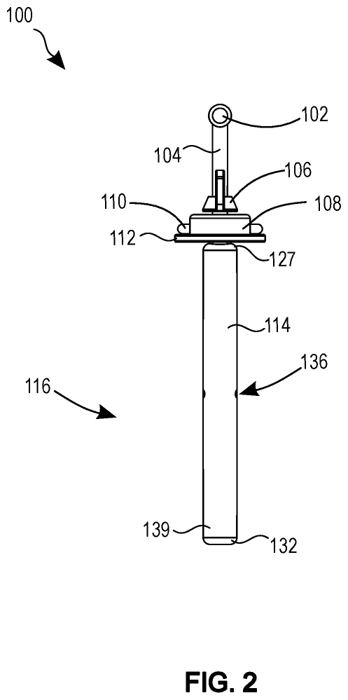

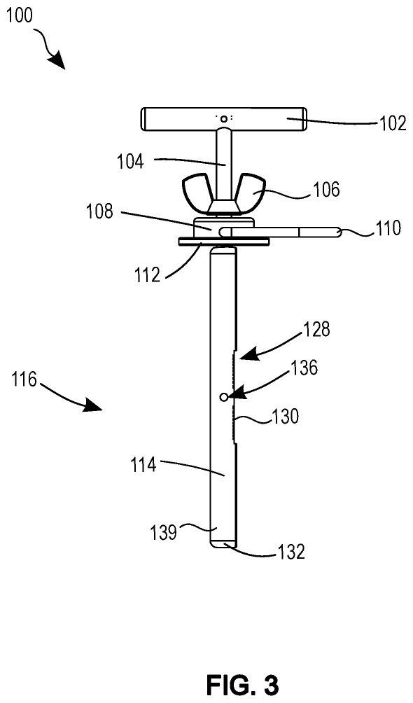

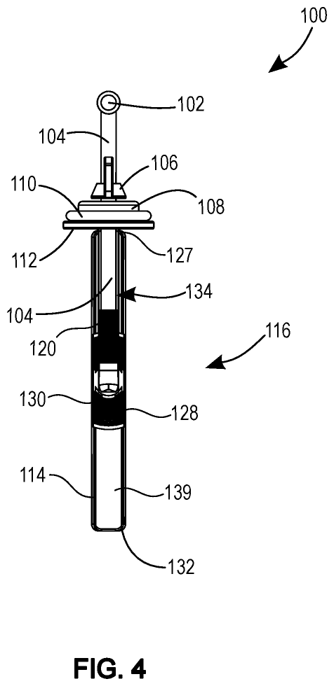

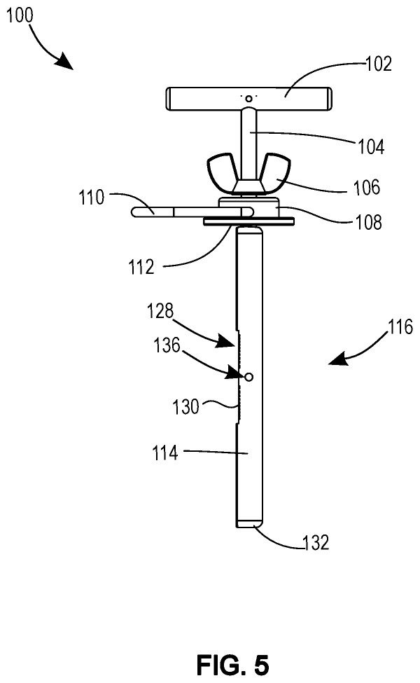

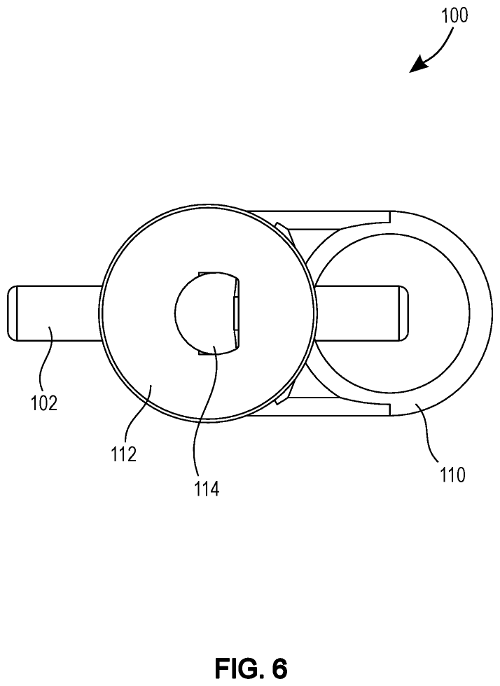

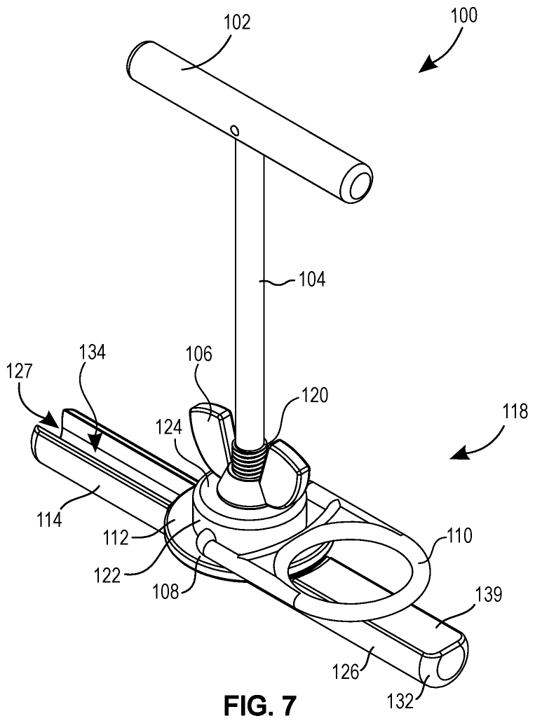

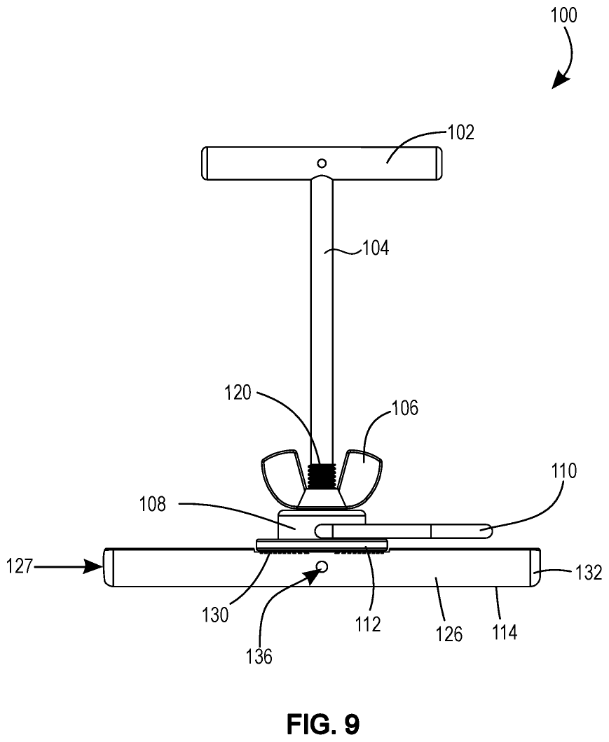

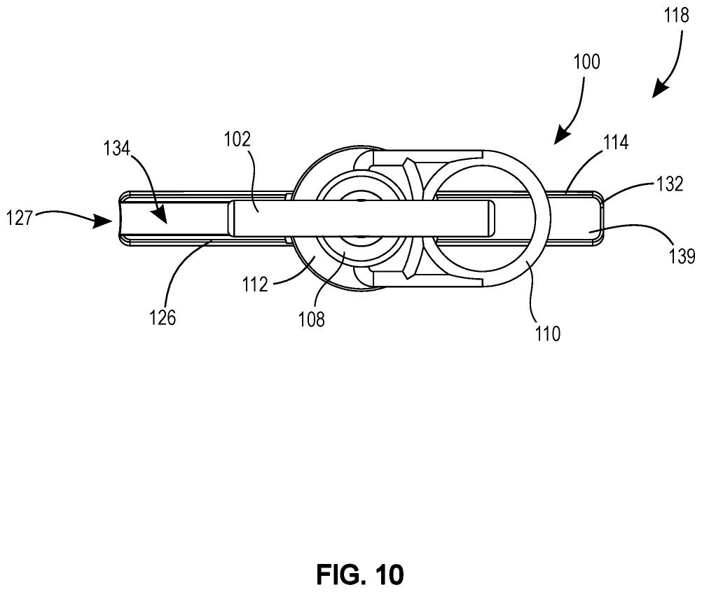

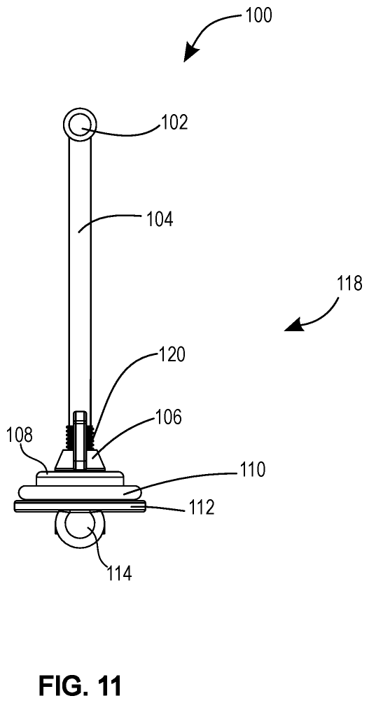

Referring to FIGS. 1-11, in some embodiments, a swivel anchor 100 comprises a handle 102, a central rod 104, a nut 106, a swivel ring 108 having an anchor ring 110 and a base member 112, and an adjustable anchor bar 114 configured to toggle between a vertical configuration 116 (FIGS. 1-6) and a horizontal configuration 118 (FIGS. 7-11). The handle 102 may comprise a cylindrical member with an ergonomic grip surface that enables a user to grasp and manipulate the handle 102. The central rod 104 may be coupled perpendicularly to the handle 102 along a transverse axis, forming a “T” shape. The handle 102 may be permanently affixed to the central rod 104, such as by welding, or may be coupled using threads, locking pins, or other mechanisms. A second end (i.e., opposite the end with the handle 102) of the central rod 104 may comprise a threaded region 120 configured to receive the nut 106.

As depicted, the nut 106 may be a wingnut having large wings, one on each side of a body of the nut 106, so that it can be easily tightened and loosened by hand without tools. The nut 106 may be hand-tightened about the threaded region 120 of the central rod 104 to secure the base member 112 of the swivel ring 108 to a surface of a roof (e.g., decking). It will be appreciated that the nut 106 may alternatively comprise a thumb nut having a ridged exterior flange that may be similarly tightened by hand, or may be a standard nut, or any fastening mechanism, operable with or without tools, capable of securing the base member 112 to the surface of the deck by interposing the decking between the base member 112 and the anchor bar 114, as will be discussed in more detail later herein.

In some embodiments, the anchor bar 114 comprises a generally tubular body 126 having a top surface 128 that comprises machined grooves 130, such as knurl patterns, that provide additional means of friction against the decking or other surface. The machined grooves 130 may be circular in orientation and correspond substantially to the shape of the base member 112. However, the machined grooves may comprise other patterns and sizes without departing herefrom. The machined grooves 130 resist rotation and other unwanted movement of the base member 112 while secured to the deck, providing a fixed anchor point for tie-offs.

In some embodiments, a diameter of the tubular body 126 is less than about 1.125 inches in order to minimize a size of a hole put in the deck through which the tubular body 126 is inserted when in a vertical configuration 116. However, it will be appreciated that other diameters may be used without departing herefrom. The tubular body 126 of the anchor bar 114 may also be configured to conform to a size of a deck flute, wherein the base member 112 is lodged within the deck flute during use. Further, the anchor bar 114 may comprise chamfers 132 or sloping edges along each end of the tubular body 126 for increased strength and to allow the chamfered end 132 to more easily penetrate the hole in the decking.

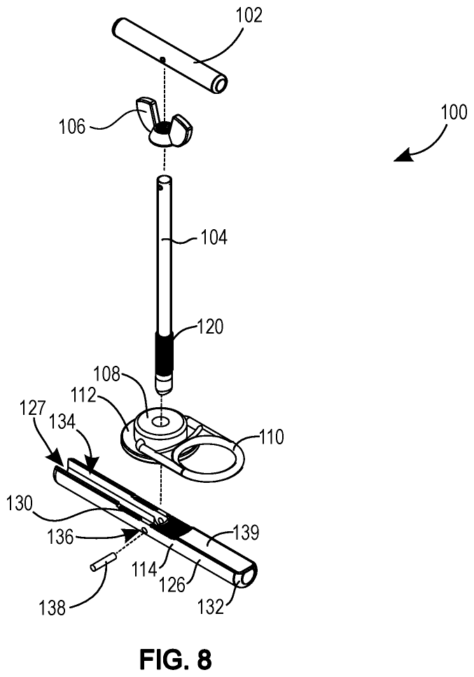

In some embodiments, the tubular body 126 comprises a channel 134 configured to align with, and envelop, the central rod 104 when the swivel anchor 100 is in a vertical configuration 116. The channel 134 may be a rounded cavity beginning near a center of the tubular body 126 and extending outwards along at least one side of the tubular body 126 towards an open end 127 (best seen in FIG. 7). The anchor bar 114 may comprise a pivot point 136 through which a hinge pin 138 (best seen in FIG. 8) may be inserted, thereby pivotably coupling the anchor bar 114 to the central rod 104.

In some embodiments, the pivot point 136 may be offset from the center of the anchor bar 114. The nature of having the pivot point 136 be offset is that it creates slight instability in the anchor bar 114 relative to the central rod 104 that promotes a natural transition between the vertical configuration 116 and the horizontal configuration 118, with the vertical configuration 116 being favored in a natural state. That instability may also be achieved by the opposite end 139 being solid or weighted to thereby promote a natural vertical configuration 116 when not in use. It will be appreciated that the channel 134 of the anchor bar 114 permits the swivel anchor 100 to collapse more compactly for increased portability around the jobsite while also allowing for easier insertion through a smaller diameter hole in the deck or other anchor surface.

Referring to FIGS. 1-6, the anchor bar 114 is shown in a vertical configuration 116 wherein the central rod 104 is received within the channel 134 of the anchor bar 114. The swivel anchor 108 rests on top of the open end 127. As discussed, either due to the pivot point 136 being offset from center, or due to the weight of the opposite end 139, or both, the anchor bar 114 naturally rests in the vertical position 116.

In some embodiments, the swivel anchor 100 may be manually toggled between the initial vertical configuration 116 and the installed horizontal configuration 118 (FIGS. 7-12). As discussed, the vertical configuration 116 is characterized by the central rod 104 being housed within the channel 134 of the anchor bar 114, wherein the central rod 104 and the anchor bar 114 extend longitudinally in relation to each other. The base member 112 and the nut 106 are positionable towards the handle 102 in the vertical configuration 116. By contrast, the horizontal configuration 118 is characterized by the pivoting of the channel 134 away from the central rod 104, wherein the anchor bar 114 becomes perpendicular to the central rod 104. The base member 112 and the nut 106 are then slidable down the central rod 104 where the nut 106 may be threadably tightened on threaded region 120, thereby prohibiting movement of the anchor bar 114.

The swivel anchor 100 may be toggled between the vertical configuration 116 and the horizontal configuration 118 by simply shaking or otherwise maneuvering the swivel anchor 100 so as to cause the anchor bar 114 to tilt from the central rod 104. Once tilted, the anchor bar 114 will catch on the deck as a user lifts upwardly on the handle 102, thereby causing the anchor bar 114 to pivot to a perpendicular position in relation to the central rod 104. With the anchor bar 114 now in the horizontal configuration 118 and held against the deck, the swivel ring 108 may be lowered down the central rod 104 to engage the threaded region 120. The decking is then secured between the anchor bar 114 and the swivel ring 108 as the nut 106 is threaded down the threaded region 120, thereby tightening the swivel ring 108 onto the decking, the decking being interposed between the anchor bar 114 and the base member 112 of the swivel ring 108.

Because the swivel ring 108 is not threaded, it is configured to freely rotate 360 degrees about the central rod 104 on the threaded region 120. This may be achievable using limited pressure by the nut 106 on the swivel ring 108 or by, in some embodiments (as shown in FIG. 7), the swivel ring 108 comprising a central portion 124 with an outer portion 122 rotatable on the central portion 124, such as by using bearings between the central portion 124 and outer portion 122. The anchor ring 110 or similar tie-down ring extends from the swivel ring 108 to provide an anchor point used by workers for fall protection. A worker may couple a harness, a lanyard, a self-retracting lifeline, etc., to the anchor ring 110.

It will be appreciated that the swivel anchor 100 is easy to install, provides a 360-degree field of work, and weighs only a few pounds. The swivel anchor 100 can be installed on concrete and steel structures with a variety of installation kits available to suit the particular site application. For example, the swivel anchor 100 may be used for both steel and concrete applications, for rescue operations, lifting, hoisting, tie-back, or related use cases where there is sufficient space beneath the surface for the anchor bar 114 to pivot. Due to the size and weight of the swivel anchor 100, workers can easily carry the swivel anchor 100 around the jobsite and install or remove as necessary, without undue weight concerns, while still providing uncompromising security and safety.

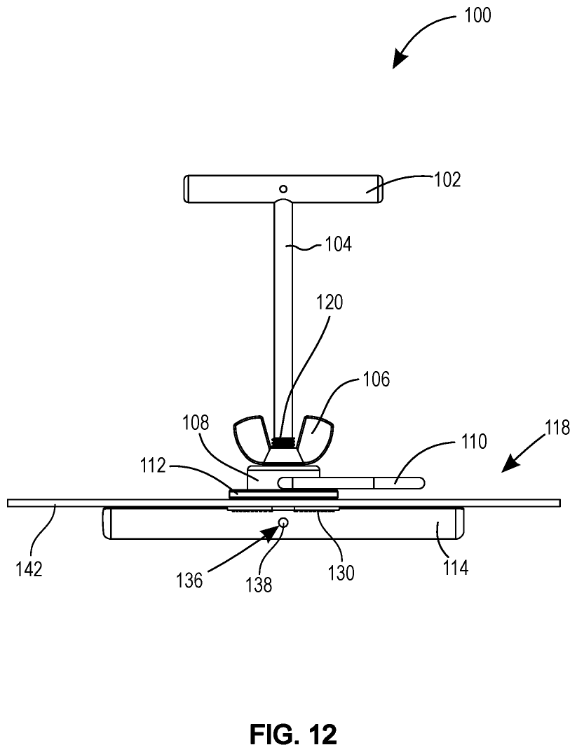

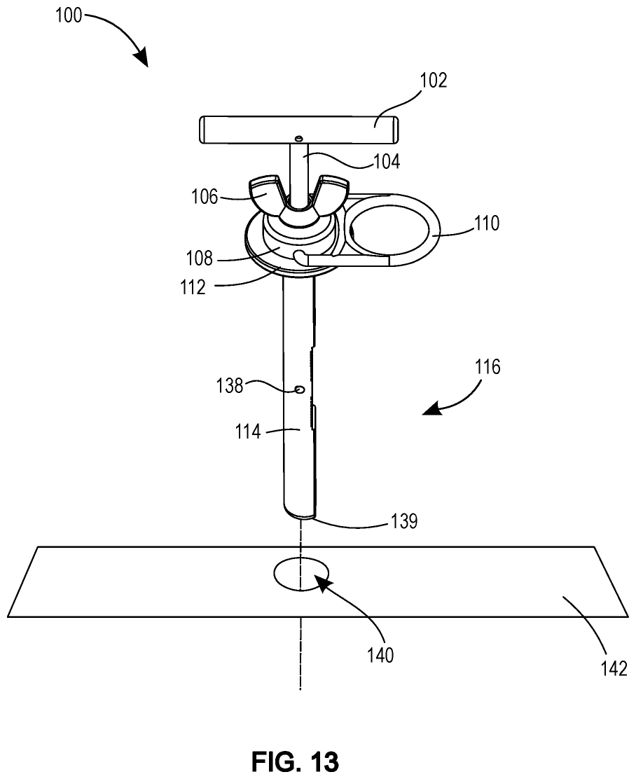

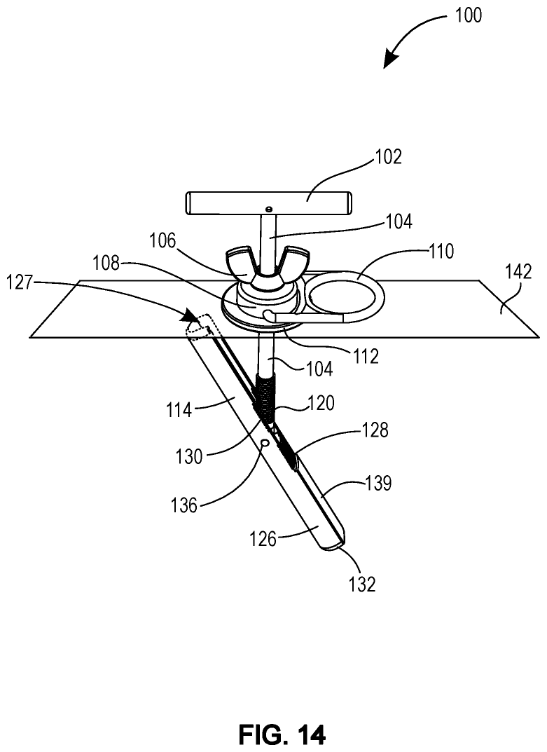

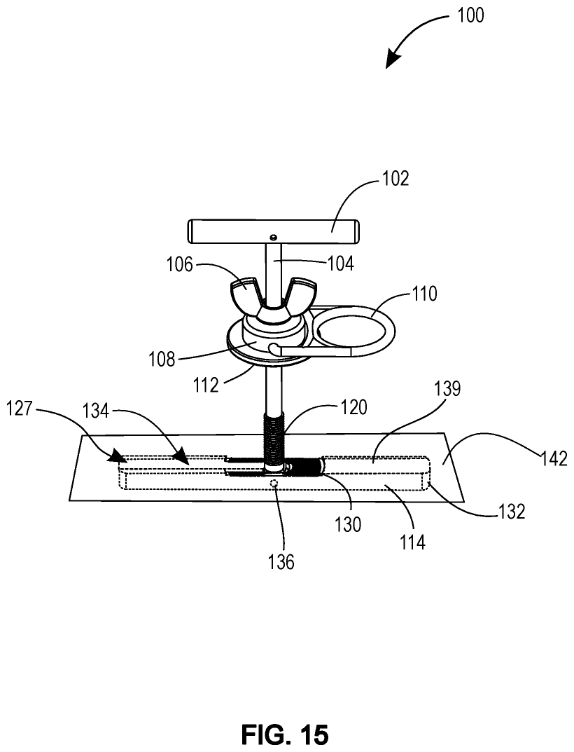

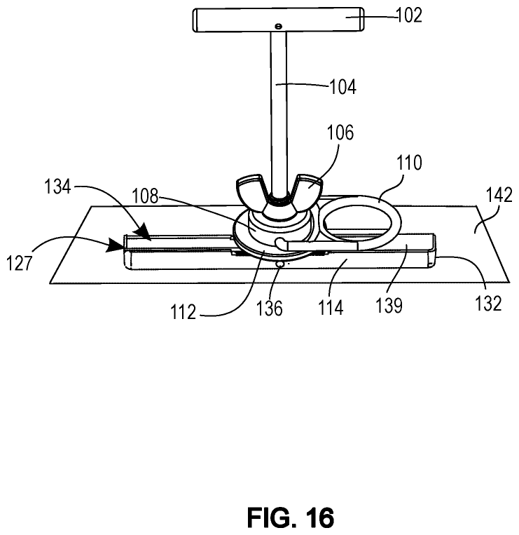

FIG. 12 illustrates the swivel anchor 100 secured to roof decking 142 for use as an anchor. Referring to FIGS. 13-16, in some embodiments, a method of using a swivel anchor 100 comprises drilling a hole 140 through a top surface of a deck 142 (or other mounting/anchoring surface). Without limitation, the hole 140 may comprise a diameter of 1.125 inches. Next, as shown in FIG. 13, the method comprises inserting end 139 of the anchor bar 114 through the hole 140 in a vertical configuration 116. Once the anchor bar 114 is fully inserted within the hole 140, a user then shakes or otherwise maneuvers the swivel anchor 100 to pivot the anchor bar 114 away from the central rod 104, as shown in FIG. 14. With the anchor bar 114 tilted, a user then pulls upwardly on the handle 102 to force the anchor bar 114 fully against the underside of the deck 142, as shown in FIG. 15. In other words, the anchor bar 114 will catch the deck 142 and be forced into a horizontal position 118. While keeping pressure up on the handle 102 away from the deck 142, the method comprises lowering the swivel ring 108 and nut 106 and hand tightening the nut 106 along a threaded region 120 of a central rod 104 to secure the deck 142 between the anchor bar 114 and the base member 112 of the swivel ring 108, as shown in FIGS. 16 and 12. Once the nut 106 is tightened, the swivel anchor 100 will be secured to the deck 142 assuring maximum surface area contact between the anchor bar 114 on a bottom side of the deck 142 and the base member 112 on a top side of the deck 142.

In some embodiments, the method further comprises coupling a safety line to the anchor ring 110 of the swivel anchor 100. It will be appreciated that installation and coupling of the safety line to the swivel anchor 100 can be accomplished within only a matter of seconds before a user is safe and ready to begin working. To release the swivel anchor 100, a user loosens the nut 106 away from the base member 112 until it is free of the threaded region 120. The user may then allow the handle 102 down towards the hole 140 in the deck 142, with the swivel ring 108 and nut 106 sliding upwardly toward the handle 102. The weight of the end 139 of the anchor bar 114 (or as a result of the offset pivot point) will swing the anchor bar 114 back to the vertical position 116 so that a user can pull it out through the hole 140, leaving only a comparatively small clean hole 140 in the deck 142. Typically, no patching of the hole 140 is necessary; however, a plug and/or other sealant may be inserted within the hole 140. Use of the swivel anchor 100 thus better maintains the structural integrity of a surface of the deck 142 as compared to other rooftop penetrating anchor systems, and is easier to install and relocate than non-penetrating rooftop anchor systems.

The swivel anchor 100 described herein solves the need for a user-friendly, dependable, and cost-effective way to tie off to steel deck. The swivel anchor 100 is installable within seconds and enables a 360-degree field of work. Accordingly, the swivel anchor 100 solves the need for an anchor that is quickly secured, does not harm the structural integrity of the building, and that allows full rotation while in use.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A swivel anchor, comprising:
a handle;
a central rod extending substantially perpendicular to the handle;
a nut slidable on the central rod and configured to threadably engage with a threaded region on the central rod;
a swivel ring configured to be slidable and rotatable on the central rod; and
an anchor bar coupled to an end of the central rod opposite the handle, wherein the anchor bar is pivotable between a first, vertical position and a second, horizontal position.

2. The swivel anchor of claim 1, wherein the anchor bar comprises a channel configured to receive the central rod when in the first, vertical position.

3. The swivel anchor of claim 1, wherein the swivel ring comprises an anchor ring.

4. The swivel anchor of claim 1, wherein the anchor bar comprises machined grooves on a top surface.

5. The swivel anchor of claim 4, wherein the swivel ring comprises a base member configured to abut the machined grooves.

6. The swivel anchor of claim 1, wherein the anchor bar further comprises a solid, weighted end.

7. The swivel anchor of claim 1, wherein a pivot point of the anchor bar is offset from center.

8. A swivel anchor, comprising:
a handle configured to couple perpendicularly to a central rod at a first end of the central rod, the central rod comprising a threaded region at a second end;
a nut slidable on the central rod and configured to threadably engage with the threaded region on the central rod;
a swivel ring configured to be slidable and rotatable on the central rod; and
an anchor bar pivotably coupled to the second end of the central rod, wherein the anchor bar is configured to pivot between a first, vertical position, and a second, horizontal position;
wherein the anchor bar comprises a channel configured to receive the central rod when in the first, vertical position.

9. The swivel anchor of claim 8, wherein the swivel ring comprises an anchor ring.

10. The swivel anchor of claim 8, wherein the anchor bar comprises machined grooves on a top surface.

11. The swivel anchor of claim 10, wherein the swivel ring comprises a base member configured to abut roof decking interposed between the base member and the machined grooves.

12. The swivel anchor of claim 8, wherein the anchor bar further comprises a solid, weighted end.

13. The swivel anchor of claim 8, wherein a pivot point of the anchor bar is offset from center.

14. A method of using a swivel anchor, the method comprising:
cutting a hole in decking;
inserting an anchor bar and at least a portion of a central rod through the hole;
maneuvering the swivel anchor until the anchor bar pivots in relation to the central rod;
with the anchor bar pivoted away at least partially from the central rod, pulling upwardly on a handle coupled to the central rod until the anchor bar abuts an underside of the decking;
lowering a swivel ring to abut a top surface of the decking, thereby interposing the decking between the swivel ring and the anchor bar;
engaging a nut on a threaded portion of the central rod until the nut abuts the swivel ring, thereby prohibiting vertical movement of the swivel ring on the central rod; and
securing a tether to the swivel ring.

15. The method of claim 14, further comprising:
loosening the nut on the threaded portion until it is freely slidable on the central rod;
lowering the central rod into the hole until the anchor bar pivots to a vertical position, the anchor bar comprising a channel to receive the central rod; and
withdrawing the central rod and anchor bar from the hole.
